(19) United States
(12) Patent Application Publication
(10) Pub. No.: US 2012/0144028 A1
(43) Pub. Date: Jun. 7, 2012

(54) MONITORING PROCESSES IN A COMPUTER

(76) Inventors: Mark Blackburn, Maidenhead (GB); Geoff Collins, Epsom (GB); Andrew Hawkins, Bracknell (GB)

(21) Appl. No.: 13/303,766

(22) Filed: Nov. 23, 2011

(30) Foreign Application Priority Data
Dec. 7, 2010 (GB) 1020662.1

(51) Int. Cl. G06F 15/173

(52) U.S. Cl. 709/224

(57) ABSTRACT

A monitoring program is run on a computer to identify a process running on the computer, and, for the identified process, determine whether or not one or more predetermined characteristics of the process complies with respective reference characteristics. This allows the program to automatically distinguish whether the process is likely to be a productive process or a non-productive process. For each characteristic a certainty value is incremented or decremented depending on whether the characteristic complies with the reference characteristic. Examples of characteristics are the time pattern of running of a process and the use of hardware resources by the process. Other characteristics include receiving input from a user and connections to known IP addresses. The monitoring process may be used to control power consumption to detect and run non-productive processes in a low power state.

This application claims benefit under 35 U.S.C. §119(a) and 37 CFR 1.55 to UK patent application no. 1020662.1, filed on Dec. 7, 2010, the entire content of which is hereby incorporated by reference.

### FIELD OF THE INVENTION

The present invention relates to monitoring processes in a computer. An embodiment of the invention relates to controlling the power consumption of a computer.

### BACKGROUND OF THE INVENTION

A computer, for example a server, may have a specific role allocated to it for providing a specific service to users. Processes running on the computer which provide that service are regarded as productive. Other processes such as defragmentation or virus checking, whilst important, do not directly provide a service to a user and are regarded as non-productive. It is desirable to distinguish productive processes from non-productive processes. Whilst processes have names and one might think that productive and non-productive processes may be distinguished from the names, in fact names are arbitrary. For example “Minesweeper” is the name of a well known computer game but any other process could have the name “Minesweeper”. Furthermore, a computer only carries out the instructions in a process and has no “knowledge” of the purpose of the process. In a large computer system there may be hundreds or more computers and records of what is running on them may be inaccurate. Manually reviewing all processes on all the computers is impractical in large systems.

It is desirable to automatically distinguish between productive and non- productive processes running on a computer to enable better administration and/or control of the computer and/or better administration of a computer system.

### SUMMARY OF THE INVENTION

In accordance with one aspect of the present invention, there is provided a method comprising running on the computer a monitoring program which identifies a process running on the computer, and, for the identified process, determines whether or not one or more predetermined characteristics of the process comply with respective reference characteristics thereby to automatically distinguish whether the process is likely to be a productive process or a non-productive process.

In accordance with another aspect of the present invention, there is provided a method comprising running on the computer a monitoring program which identifies a process running on the computer, and, for the identified process, detecting the time pattern of running of the identified process and the resources it uses when running thereby to automatically determine whether the process is likely to be a productive process or a non-productive process.

Further features and advantages of the invention will become apparent from the following illustrative description of embodiments of the invention, given by way of example only, which is made with reference to the accompanying drawings.

### BRIEF DESCRIPTION OF THE DRAWINGS

FIG. 1 is a schematic diagram of a network of computers;

FIG. 2 is simplified schematic diagram of an illustrative computer of FIG. 1;

FIG. 3 is a schematic diagram of an operating system and programs present on a computer of FIG. 1;

FIG. 4 is a schematic diagram of an operating system and programs present on an administrator's workstation of FIG. 1;

FIG. 5 is a schematic diagram of the contents of a database of FIG. 1;

FIGS. 6A and 6B are a flow chart of an example of a computer implemented method of monitoring processes in accordance with the invention;

FIG. 7 is a flow chart illustrating a method of controlling a the power consumption of a computer in accordance with an example of the present invention;

FIG. 8 is a diagram illustrating the calculation of net CPU activity;

FIG. 9 is a diagram illustrating the determining a net number of TCP/IP connections; and

FIG. 10 is a diagram illustrating the calculation of net I/O activity.

### DETAILED DESCRIPTION OF ILLUSTRATIVE EMBODIMENTS OF THE INVENTION

### Overview

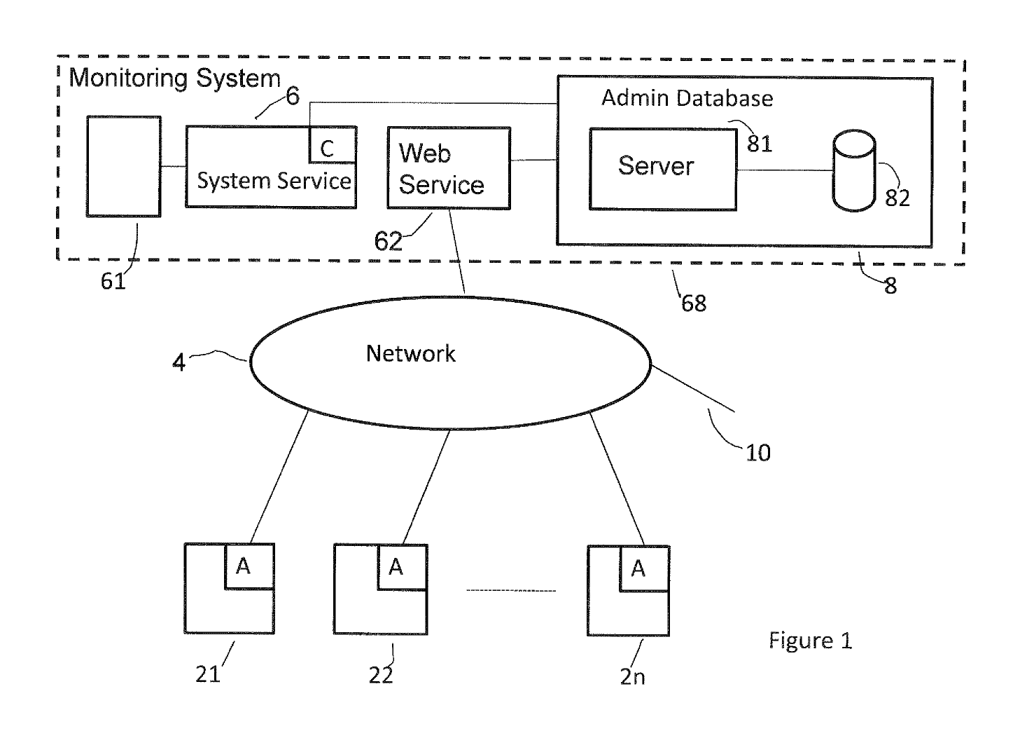

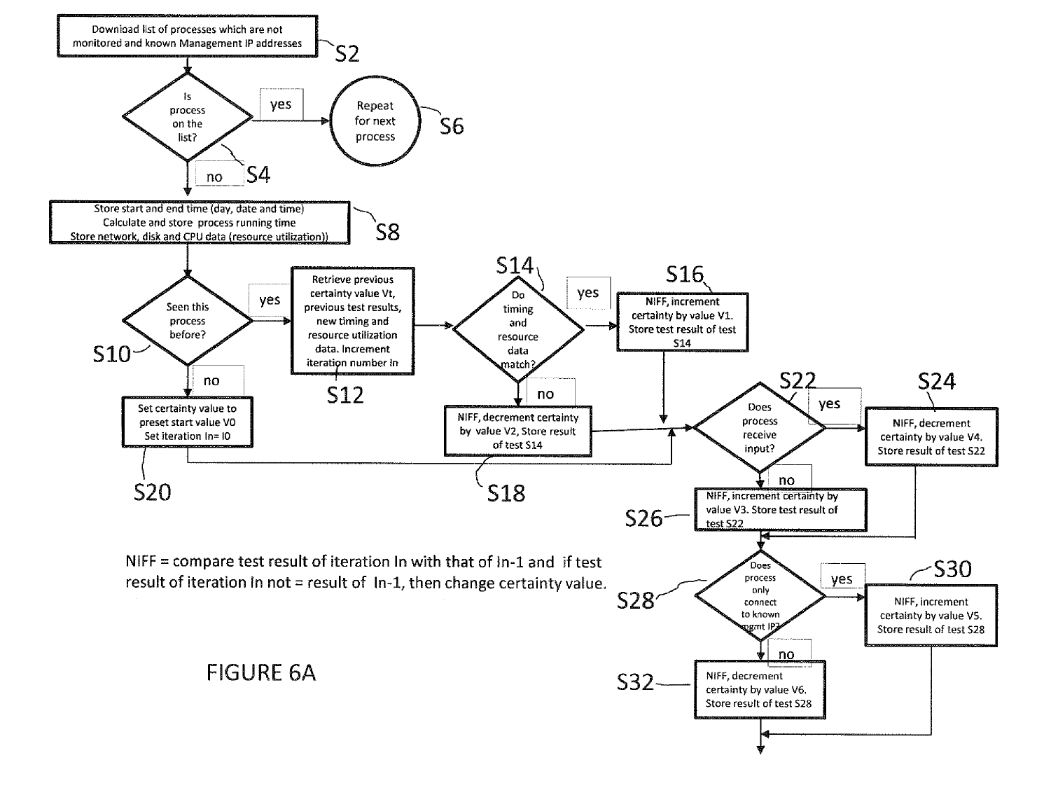

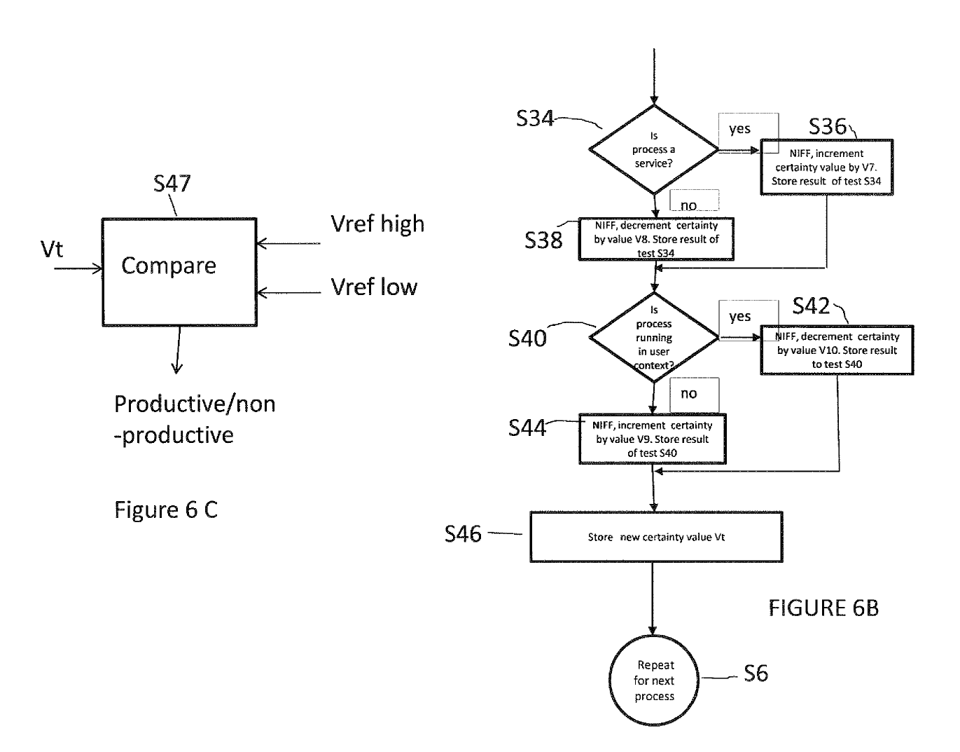

An illustrative example of the present invention comprises a network of computers: see FIGS. 1 to 5. One or more of the computers is/are monitored to automatically produce a data set of “excluded processes” and a data set of “excluded network connections” which are processes and connections deemed to be non-productive: see FIGS. 6A and 6B. The data sets are stored in a database.

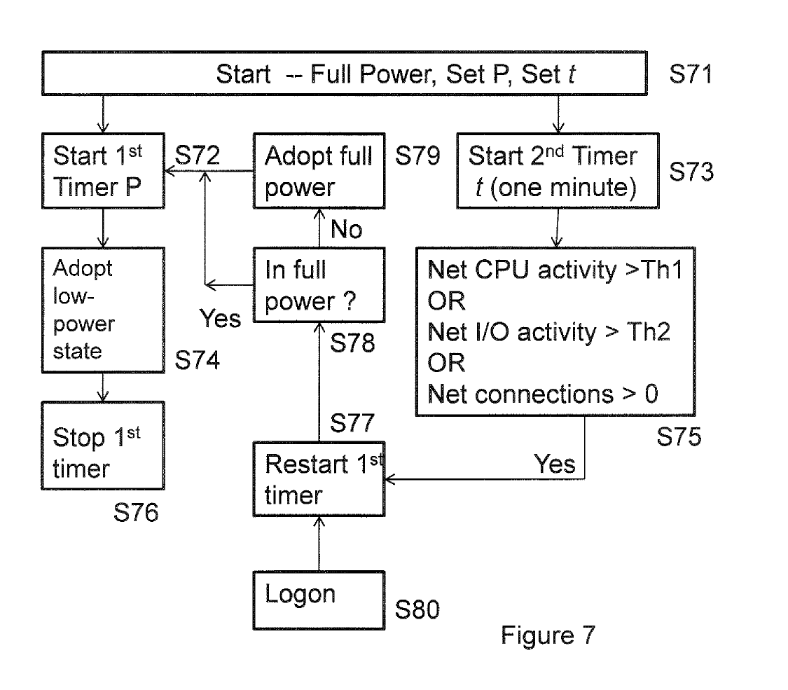

The data sets may be used for power control of the computers based on “net useful work” which is a value of activity of the computer excluding contributions to the activity of the excluded processes and network connections: see FIGS. 7 to 10.. The method of power control of FIGS. 7 to 10 is the subject of the applicant's co-pending U.S. application Ser. No. 12/860956 filed Aug. 23, 2010 and claiming priority from UK patent application 0915235.6, the entire content of which is hereby incorporated by reference.

Overview of an example of a system in accordance with the invention: FIGS. 1 to 5.

Referring to FIG. 1, the system comprises computers, in this example computers 21, 22, 2n, an administrator's workstation 6 with a display device 61, a web service 62 running on a computer, and an administrative database 8, connected by a network 4. The computers may be PCs, laptops amongst other types of computer. Alternatively, or additionally, the computers may be servers of a large server farm having a large number of servers, for example hundreds or more servers.

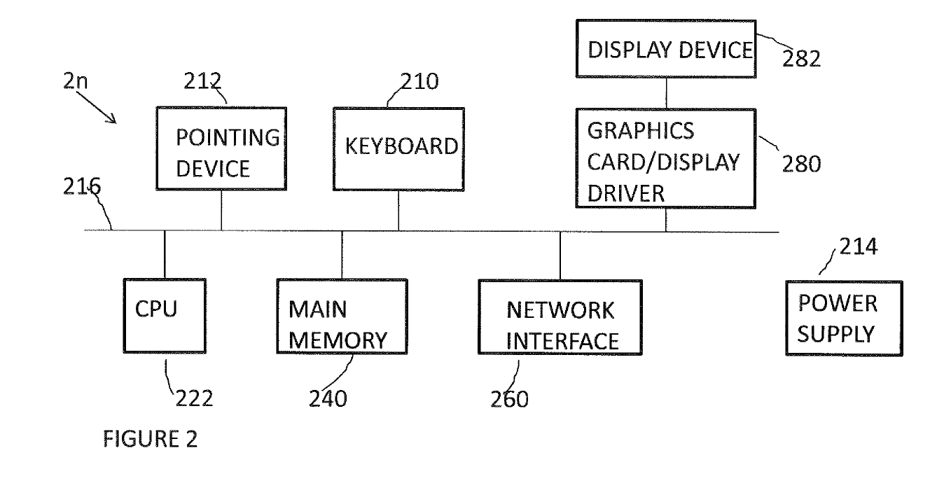

Referring to FIG. 2, an illustrative one of the computers 2n comprises, amongst other items: a CPU 222; a main memory 240 for example a hard disk drive or other storage device, for example electronic memory; a network interface 260; a display driver 280 coupled to a display device 282; human interface devices or input devices for example a keyboard 210 and a pointing device 212; and one or more busses 216; The items are conventional and interact via the buss(es) in a conventional way. The network interface couples the computer to other computers 21 to 2n having respective IP (Internet Protocol) addresses. The computer also comprises a power supply 214.

It should be noted that the present invention may be implemented in software and/or in a combination of software and hardware, e.g., using application specific integrated circuits (ASIC), a general purpose computer or any other hardware equivalents. In one embodiment, the various processes can be loaded into memory 240 and executed by processor 222 to implement the functions herein. As such the processes (including associated data structures) of the present invention can be stored on a computer readable medium or carrier, e.g., RAM memory, magnetic or optical drive or diskette, and the like.

The administrator's workstation 6 interacts with the database 8. The webservice 62 interacts with the database and the computers 2n. The database may itself comprise a server 81 having a data storage device 82. The database 8 and the workstation 6 together form a monitoring system 68.

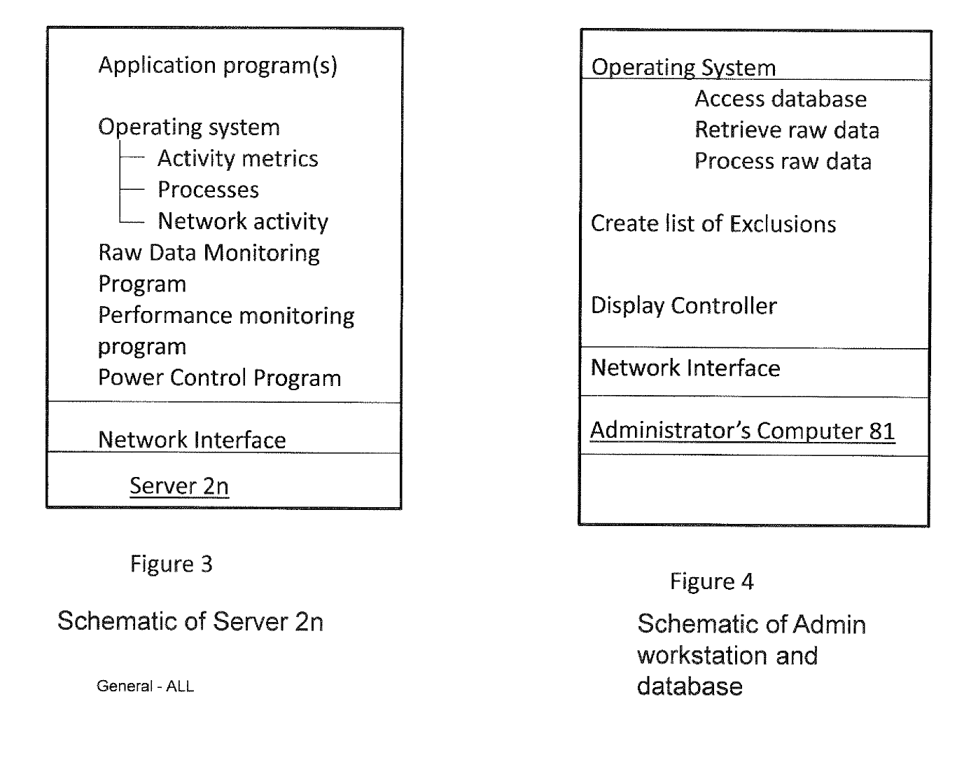

In this example of the invention, as illustrated in FIG. 3, each computer 2n has, amongst other programs: an operating system; one or more application programs which define the role of the computer; a monitoring program, denoted A in FIG. 1, which monitors activity of the computer; and a network interface. The monitoring program interacts with the operating system to obtain the data including information identifying the computer and other data, relating to the activities of the computer as described herein below. The monitoring program A sends the data to the database 8 via the network interface, the network 4 and the webservice 62 which transfers the data to the database 8. In this example, the monitoring programs A communicate with the webservice using the http protocol. In the example of FIGS. 1 to 5, each computer 2n has a power control program which controls the power state of the computer as described herein. The power control program interacts with the operating system to obtain data relating to the activities of the computer. Power control may be performed as described with reference to FIGS. 7 to 10 using information derived from the data produced by the monitoring programs A. In this example, as indicated in FIG. 4, the administrator's workstation 6 has, amongst other programs, an operating system, a network interface, a display controller, and a program for interfacing with the database.

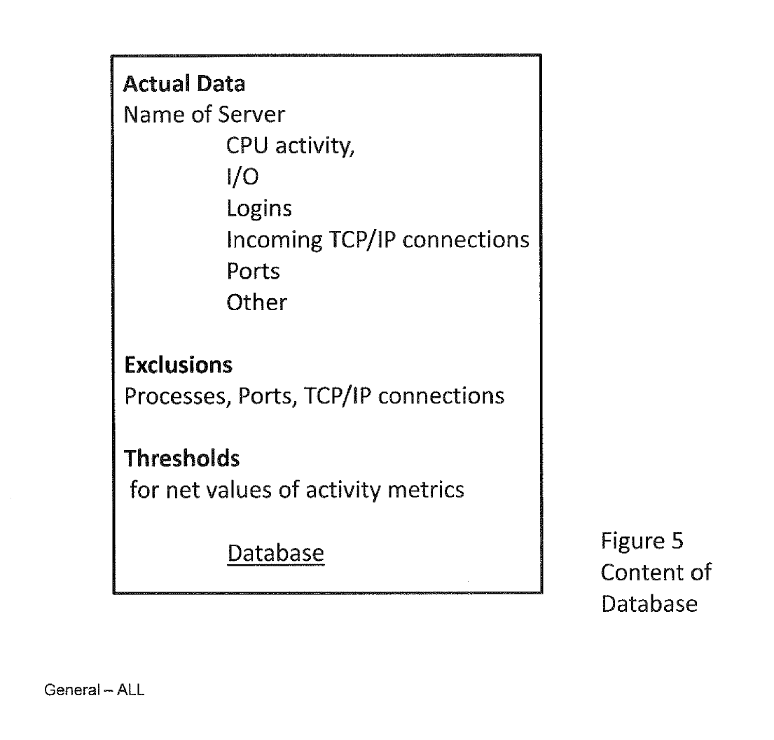

As illustrated by FIG. 5, the database 8, 81, 82 stores the summarised or otherwise processed data provided by the monitoring program A of a computer. In this example the data includes: the name of the computer; metrics of CPU activity, I/O, logins, and incoming TCP/IP connections; names of processes; and identification of incoming TCP/IP connections by a combination of port number used and processes associated with the port and the connection. The database may also store source IP addresses of incoming network connections, and other data for example data identifying any connection to a process X, any connection to a port Y or any connection from a source address Z.

The database processes the data to store it in an organised way.

In one embodiment, raw data produced by the monitoring program A of a computer 2n is analysed in computer 2n as discussed below with reference to FIGS. 6A and 6B to produce a data set of excluded processes and of excluded incoming TCP/IP connections to be used by the power control process of FIGS. 7 to 10. Also thresholds of activity metrics set by the administrator are stored in the database. In another embodiment the computer 2n sends the raw data to the database server to be analysed, but that may impose a high load on the network.

FIGS. 6A to 6C are a flow chart of an illustrative process for producing monitored data. The process of FIGS. 6A to 6C takes place in each of the computers 21 to 2n and the results are sent to the database 8 over the network. Before being sent the monitored data may be summarised or otherwise processed. The data sent to the database may be summarised or otherwise processed data in order to reduce the load on the network and the size of the database. In one example, the identity of each process being monitored and the result of the last certainty test are stored locally and batches of data representing the identities and results are sent at intervals to avoid loading the network with a persistent stream of messages.

Consider one of the computers 2n. The illustrative program of FIGS. 6A and 6B operates to identify processes running on the computer and to determine whether they are likely to be productive processes providing a service to a user or otherwise fulfilling the role allocated to the computer or whether they are non-productive processes fulfilling tasks which do not directly provide a service to a user for example virus checking or defragmentation. The monitoring program A determines whether predetermined characteristics of the monitored processes comply with reference characteristics. The chosen reference characteristics may include characteristics typical of a process which is typical of a productive process (or, alternatively, typical of a non-productive process). The chosen reference characteristics may alternatively, or additionally, include data relating to the time pattern of running of the monitored process and/or use of resources characteristic of a productive process (or, alternatively, characteristic of a non-productive process).

In the illustrative procedure described now with reference to FIGS. 6A and 6B, an arbitrary certainty value Vt is calculated as a measure of whether a process is productive or unproductive. A high positive value indicates a high certainty that the process is unproductive. A low value, which in this example could be negative, indicates a high certainty the process is productive.

The certainty value Vt is the aggregate of values V0 to Vp associated with P+1 tests. Each test is indicative of whether a process running on the computer has a characteristic indicative of a productive process or of an unproductive process.

In the illustrative example of FIG. 1, the tests are repeated over many iterations. For each single test, at an iteration In, the certainty value Vt is changed only if the result of the test at iteration In differs from the result of the previous iteration In−1. The value Vt in this example is incremented by +1 or decremented by −1 if the result at iteration In differs from the result at In−1 or is unchanged if the result of the test at iteration In is the same as at In−1. There are five tests in the example of FIG. 6 so Vt has a maximum value of +5 and a minimum value of −5. One or more thresholds are set to determine whether a process is productive or unproductive.

Referring by way of example to FIGS. 6A and 6B, in step S2, a list of known processes which not are to be used in the determination of whether or not a process is productive is downloaded from the administration server 22. [This list is not the data set of “excluded processes” used to determine “net useful work” as described with reference to FIGS. 7 to 10] Also a list of known IP addresses of other computers is also downloaded.

In step S4, the monitoring program finds from the operating system the name of a process which is running on the computer 2n, and compares the name with the downloaded list of processes not to be used in the program of FIG. 6. The list may include the monitoring program of FIG. 6. If the process is in the list another process is chosen in step S6. If the process is not listed then in step S8, the name of the process is stored in the computer 2n together with time and resource data relating to the day, date and time of the start and end times of the process, the running time, and the resources used. Resources used may include for example CPU utilization which is derived from the operating system. Resources used may also or alternatively include primary memory utilization which is measured as the peak and total memory usage at start and end times of a monitoring period. Resources used may also or alternatively include network usage which involves recording the network port used to transmit data and the amount of data transmitted. The time and resource data is derived from the operating system in a conventional way. The time and resource data is stored in a data store which may be part of the primary memory 4 of the computer. In addition a certainty value associated with the process is stored as will be explained in the following description.

Step S10 determines if the time and resource data of the process has been recorded on a previous occasion by comparing the name of the process with name data previously stored in step S8. If the process has not been recorded previously, at step S20 a certainty value is set to a predetermined initial amount V0 which may for example be zero but could be another number.. The certainty value is stored. Also an iteration number In is set to I1 for the first iteration of the procedure of FIG. 6 to the process.

If the process has been recorded before there will be a certainty value Vt associated with the process from the one or more previous occurrences of the procedure of FIG. 6 In step S12, the previously recorded time and resource data and the previously stored certainty value Vt are retrieved and in step S14 the current time and resource data are compared with the previous data. If the current data matches (within a predetermined tolerance) the previous data, previously stored certainty value is incremented by a predetermined amount V2 in step S16 otherwise it is decremented by V1 in step S18. The incremented or decremented certainty value is stored in the data store replacing the previously stored value. Also the iteration number I is incremented by +1 to In.

Steps S10 to S20 determine the time pattern of running of each process and the time pattern of resource usage of each process. In this example, if a process is found to run at the same time (within a predetermined tolerance) as on a previous occurrence and uses the same resources as on the previous occurrence, (and ignoring the issue of whether the same result was found on a previous iteration), the certainty value is incremented indicating that there is an increased certainty that the process is a non-productive process, for example virus checking or defragmentation, which as a matter of policy runs at regular times and tends to always use the same resources.. Conversely, if the certainty value decreases, that indicates there is a greater certainty that the process is a productive process serving a user because experience shows that user related services occur at times which are more random and use resources more randomly than non-productive processes.

It will be appreciated that the time data may be processed separately from the resource data and each used to provide separate increments (or decrements) to the certainty value. Resource usage is recorded together with the time of usage of the resources. The method then proceeds to steps S22 to S46 where it is deter wined if one or more other characteristics of the monitored process comply with one or more predetermined reference characteristics. For the, or each, characteristic, (again ignoring the issue of whether the same result was found on a previous iteration), the certainty value is incremented or decremented. Steps S22 to S46 may be carried out as an alternative to steps S8 to S20 or as shown in FIG. 3 in addition to steps S4 to S20. Steps S22 to S46 may precede steps S4 to S20. Steps S22 to S46 may be implemented in a different order to that shown in FIG. 6. Some steps may be omitted; for example steps S22, S24 and S26 may be omitted for computers e.g. servers which do not receive direct human input.

Referring to step S14, if the process has been seen before on an iteration In−1, step S14 tests whether the timing and resource data of iteration In match those of iteration In−1. If the answer is No (indicating a productive process) and if the result of the test of step S14 at iteration In differs from the result at iteration In−1, then the certainty value Vt is decremented by 1 at step S18 and the result of the test is stored with the iteration number. If the answer is Yes (indicating a non-productive process), and if the result of the test of step S14 at iteration In differs from the result at iteration In−1, then the certainty value Vt is incremented by 1 at step S16 and the result of the test is stored with the iteration number. If the result of the test of step S14 at iteration In is the same as the result at iteration In−1, then the certainty value Vt is unchanged, but the result of the test is stored with the iteration number.

Step S22 determines if the monitored process receives input from for example the keyboard 10 or pointing device 12 or from another human interface device or another source of input. A PC or laptop typically receives direct input via a keyboard or pointing device or other human interface. A server may receive input indirectly from a client. If the answer is No (indicating an unproductive process) and if the result of the test of step S22 at iteration In differs from the result at iteration In−1, then the certainty value Vt is incremented by 1 at step S26. If the answer is Yes (indicating a productive process), and if the result of the test of step S22 at iteration In differs from the result at iteration In−1, then the certainty value Vt is decremented by 1 at step S24. If the result of the test of step S22 at iteration In is the same as the result at iteration In−1, then the certainty value Vt is unchanged. The result of the test S22 is stored with the iteration number.

Step S28 determines if the monitored process connects to a known IP address, i.e. one of the IP addresses of the list downloaded in step S2. If the process connects only to the known IP address, then that is indicative of a non-productive process. If the answer is No (indicating an productive process) and if the result of the test of step S28 at iteration In differs from the result at iteration In−1, then the certainty value Vt is incremented by 1 at step S32. If the answer is Yes (indicating a non-productive process), and if the result of the test of step S28 at iteration In differs from the result at iteration In−1, then the certainty value Vt is decremented by 1 at step S30. If the result of the test of step S28 at iteration In is the same as the result at iteration In−1, then the certainty value Vt is unchanged. The result of the test S28 is stored with the iteration number.

Step S34 determines if the process is a “service” which is a Windows term which describes a process that generally runs without the user being aware and for the present purposes is regarded as unproductive. An example would be the process which keeps the clock in sync by periodically making a network connection to a trusted clock. The Operating System indicates if the process is classified as a service. In Unix Operating Systems these types of process are called Daemons.

If the answer is No (indicating an productive process) and if the result of the test of step S34 at iteration In differs from the result at iteration In−1, then the certainty value Vt is decremented by 1 at step S38. If the answer is Yes (indicating a non-productive process), and if the result of the test of step S34 at iteration In differs from the result at iteration In−1, then the certainty value Vt is incremented by 1 at step S36. If the result of the test of step S34 at iteration In is the same as the result at iteration In−1, then the certainty value Vt is unchanged. The result of the test S34 is stored with the iteration number.

Step S40 determines if the monitored process is running in user context.

If the answer is No (indicating an unproductive process) and if the result of the test of step S40 at iteration In differs from the result at iteration In−1, then the certainty value Vt is incremented by 1 at step S44. If the answer is Yes (indicating a productive process), and if the result of the test of step S40 at iteration In differs from the result at iteration In−1, then the certainty value Vt is decremented by 1 at step 42. If the result of the test of step S40 at iteration In is the same as the result at iteration In−1, then the certainty value Vt is unchanged. The result of the test S40 is stored with the iteration number.

In step S46 the aggregate certainty value Vt is stored in the data store with the name of the monitored process and other data gathered in step S8.

The monitoring process than proceeds to monitor another process at step S6.

In the description above, Vt is incremented or decremented by 1 on all tests. However, the tests may be associated increments and decrements as follows.

| Test | Increment | Decrement |
|---|---|---|
| S14 | V1 | V2 |
| S22 | V3 | V4 |
| S28 | V5 | V6 |
| S34 | V7 | V8 |
| S40 | V9 | V10 |

The values V1 to V10 may be the same. Alternatively they may be different allowing different ones of the tests S14, S22, S28, S34 and S40 to have different weightings and to allow different weightings for different outcomes of the criteria; e.g. an increment may be different from a decrement on a particular test.

The aggregate value Vt is compared in step S47 (FIG. 6C) with two reference values to determine whether the associated process is productive or unproductive. One of the two thresholds is a “high” positive number which if exceeded indicates non-productive processes and the other a “low” number which indicates productive processes. No decision is applied to a process which has a score between the two reference values.

The two threshold values may be made equal or replaced by a single threshold.

Network Connections

The program of FIGS. 6A and B monitors processes of a computer 2n to determine which are to be deemed non-productive for producing the data set of “excluded processes”. Network connections may also be deemed non-productive or excluded. Network connections may be listed as excluded manually by the administrator. Alternatively they may be automatically monitored in a manner similar to the monitoring of processes. There are two scenarios:-
1)—A process receives input via the network on a particular port; and
2)—A process communicates (outbound) via the network on a particular port to a specific IP known to be part of a management system.

### Power Control

The monitoring procedure described above produces a data set, or list, of non-productive processes. The data set may be used for the control of power consumption of the monitored computer. The data set may be used for the control of power consumption of other computers. As described in the following example of power control, a value of net useful work is calculated for the purpose of power control. The net value is the value of activity excluding contributions to that value of predetermined processes referred to as “excluded processes”. The excluded processes are the non-productive processes identified in a data set. The monitoring procedure described above with reference to FIGS. 6A and 6B automatically produces the data set which is stored in the database 8.

### Example of Power Control

### Overview: FIG. 7

The illustrative methods use net values of activity. In the method of FIG. 7, the method uses net CPU activity, net I/O data amounts and net number of TCP/IP connections as measures of the performance of a computer. These net values are the total values of those activity metrics minus contributions to those total values from predetermined activities. In one example, those predetermined activities are activities which are considered to not contribute directly to the main purpose of the computer and are referred to herein as excluded activities. Measurement of the net values will be discussed in more detail with reference to FIGS. 7 to 10 below.

Referring to FIG. 7, at step S71, a computer operates at full power at start up. First and second timers are started in steps S72 and S73 respectively. The first timer has a selectable first time period P which it measures. That period is a relatively long period of for example 30 minutes or any other suitable period. The period P may be preset by the designer or be selectable by the user in step S71. The second timer measures a shorter time period t of a sampling period or time slot. The time slot may be for example one minute or any other period which is short compared to the period P measured by the first timer. The period t may be preset by the designer or be selectable by the user in step S71.

The method of FIG. 7 determines if there is no net useful activity for period P, e.g. 30 minutes and then causes the computer to adopt a power state referred to herein as a “low power state” which will be described below in more detail. The second timer causes the method to sample the net activity every time slot, e.g. every minute. If in any time slot net useful activity is detected, the first timer is reset. If the computer was in the full power state at reset then it continues in the full power state. If the computer was in the low power state at reset, it is forced S79 into the full power state.

In step S75, in each time slot t the method checks the net values of: CPU activity; I/O data amount; and number of TCP/IP connections. Each net value has an associated threshold value. The net values are compared with the thresholds in step S75.

If any one or more of the net values exceeds its associated threshold, indicating net useful work the first timer is reset in step S77 and step S78 determines if the computer is in the full power state. If it is in the full power state no further action is required and the first timer starts to time its period P at step S72 and the method continues to measure the net values and compare them with the thresholds in the next time slot t. If the computer is in the low power state it is forced into the full power state and the first timer starts to time its period P at step S72 and the method continues to measure the net values and compare them with the thresholds in the next time slot t.

If over the whole period P step S75 does not detect any net useful work then the first timer is not reset and at the end of the period P, in step S74, the computer adopts the low power state and the first timer is stopped. The second timer continues at step S73 and step S75 continues until net useful activity is detected and then the first timer is reset to time period P.

In this example, useful activity is in two categories: the activities sampled in step S75 which are sampled once per minute and thus do not have immediate effect on the power state of the computer; and other activities which immediately cause the computer to adopt the full power state if it was in the low power state as indicated by step S80. In this example there is only one such other activity which is a logon S80 by a user. In alternative embodiments, other events may cause the computer to adopt the high power state S79 or reset S77 the first timer. Such events may be a network event, a process appearing, an activity metric associated with a particular process crossing a threshold value, a service starting or an operating system event occurring. In an embodiment, the user or designer may specify one or more events which cause the computer to adopt the high power state or reset the first timer.

Logon may be included in the activities sampled in step S75. Any of the activities of step S75 may be subject to step S73.

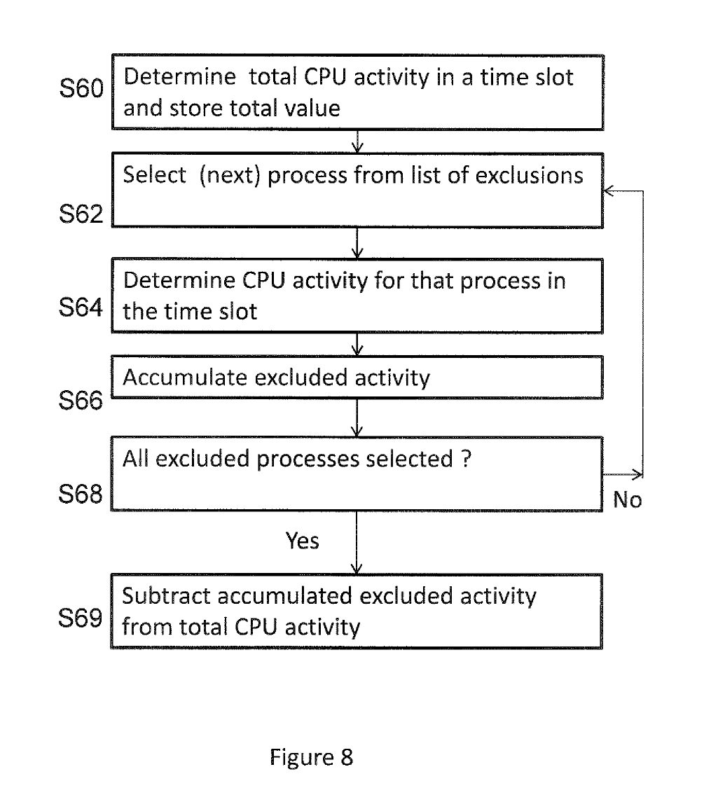

Determine net useful CPU activity: FIG. 8

Net useful CPU activity is measured as shown in FIG. 8. The measurement of net useful activity is based on the data set of excluded processes, (The production of the data set is described above with reference to FIGS. 6A and 6B).

In step S60, the total value of CPU activity is determined at the time of a time slot t and the total value is stored. The total value includes for example contributions from all processes running on the computer at the time of measurement plus activity attributable to the kernel of the operating system.

In steps S62 to S68, the contributions to the total value from all the excluded processes running at the time of measurement of the total are determined and subtracted from the total value to produce a net value. In this example that is done by selecting a process in step S62 from the data set of excluded processes, determining the activity value attributable to that excluded process in step S64, storing the activity value in an accumulator in step S66 and then at steps S68 and S62 selecting the next process and adding its activity value to the value stored in the accumulator in step S66. Once all the processes have been selected the value accumulated in step S66 is subtracted in step S69 from the total stored in step S60 to give the net value.

It will be appreciated that there are other methods of determining net useful CPU activity. For example the activity values of the excluded processes may be subtracted one at a time from the total value of CPU activity instead of accumulating all the activity levels and then subtracting the accumulated values from the total CPU activity value.

The total activity of the CPU as measured in the time slot t and the activity values of the excluded processes are derived from the operating system in known manner using performance counters.

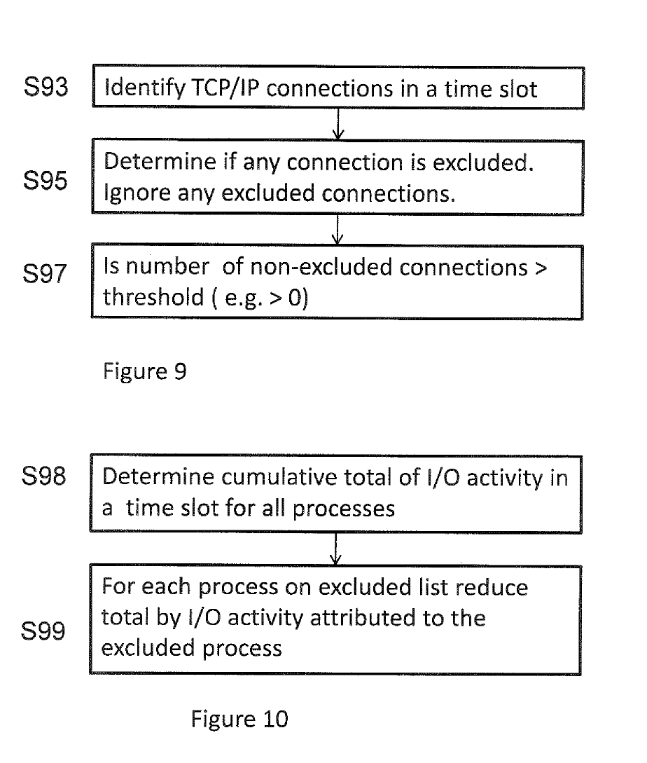

Determine net useful TCP/IP connections: FIG. 9

Net useful connections are determined as shown in FIG. 9. In the time slot t, the incoming TCP/IP connections are identified in step S93. As with CPU activity there is a list of excluded connections. The excluded connections are identified in step S95 and ignored. Step S97 determines if the number of non-excluded incoming connections exceeds a threshold. In this example the threshold is zero, so if there is a single non-excluded incoming TCP/IP connection, that is sufficient to indicate useful activity. Steps S95 and S97 may be achieved by continuously monitoring incoming TCP/IP connections. Any useful connection, i.e. one not on the excluded list, sets a flag; connections on the list are ignored.

The identification of an incoming TCP/IP connection is achieved using port numbers and processes which are provided by instrumentation data provided by the operating system. Information on how to do this is available from Microsoft Corporation for operating systems supplied by them but the invention is not limited to Microsoft's operating systems. The list of excluded incoming TCP/IP connections is a list of port numbers and processes associated with those port numbers. The following may also be identified and used in the list: source IP addresses of incoming network connections, and other data for example data identifying any connection to a process X, any connection to a port Y or any connection from a source address Z.

In an alternative implementation, in a time slot t, the total number of all incoming TCP/IP connections is determined, the number of those connections on the excluded list is determined and the number of excluded connections is subtracted from the total number of all incoming TCP/IP connections.

Determine net useful I/O activity: FIG. 10

The measure of I/O activity is the average number of bytes being read and written over the measurement period.

In this example, I/O activity is a single value which is the sum of network I/O, disc I/O and device I/O.

Net useful I/O activity is determined as shown in FIG. 8. In step S98, the total I/O activity is determined at the time of a time slot t and the total value is stored. The total value includes contributions from all processes running on the computer at the time of measurement plus activity attributable to the kernel of the operating system. In step S99, the activity of each excluded process is subtracted from the total activity of step S98 and the net value determined.

Steps S98 and S99 may be implemented as shown in FIG. 8 with I/O activity substituted for CPU activity. The list of excluded processes is the same for both CPU activity and I/O activity in this example, but different lists may be used for CPU activity and I/O activity.

I/O activity associated with the storage of the computer may be monitored separately from network I/O. Also device I/O may be monitored separately. If so, net useful values are determined separately for each type of I/O activity.

Lower Power state

As described above, the computer is in a full power state until no useful activity occurs for a period of time P, when it adopts a lower power state. In an example of a lower power state the computer is set to operate in its lowest power state whilst still fully operational. For example the CPU is controlled to operate in its minimum power state with the clock at its lowest frequency setting, and network cards and other cards of the computer are set to their lowest power state and lowest frequency of operation.

Variants

The above embodiments are to be understood as illustrative examples of the invention. Further embodiments of the invention are envisaged.

The example of power control described above monitors incoming TCP/IP connections. That aspect of the invention is not limited to TCP/IP but may be applied to other connection oriented communications protocols. The invention is not limited to monitoring incoming connections: it may monitor outgoing connections in addition to or instead of monitoring incoming connections.

The example of power control described above deems any single log-on to be useful activity. That aspect of the invention is not limited to a single logon: it may require a minimum number of logons greater than one to signify useful work. An embodiment of the invention may use a data set of one or more excluded logons. For example a logon which is not associated with an external service may be deemed to be a non-productive activity. For example, a logon to an account that is used only for maintenance tasks may be considered to be a non-productive activity.

The computers 2n of the network of FIG. 1 may all be controlled in the same way with the same data sets of excluded processes and network connections. However, the computers 2n may be controlled using different data sets of excluded processes and network connections. Each computer may be separately monitored to create data sets specific to that computer. The data sets specific to a computer would be stored in the database with an identifier which associates the data sets with the specific computer.

Examples of power control have been described which involve monitoring a plurality of activities, for example CPU activity, I/O activity, network connections and logons. However, power control may be implemented by monitoring two activities for example CPU activity and I/O activity; or three activities. More than four activities may be monitored. For example a single measure of I/O activity may be replaced by separate measures of network I/O, disc I/O and device I/O.

Whilst the invention has been described by way of example as using programs running on each of the computers 2n to monitor and control the computers, the computers may be monitored and controlled remotely by for example the monitoring system 68 of FIG. 1.

The embodiments of power control described above sample the total values of one or more activity metrics in each of a succession of time slots. However, an alternative embodiment uses an event monitor instead of time slots and senses the occurrence of an event to initiate sampling of total values and determine the net values.

Whilst the invention has been described by way of example to changing the aggregate certainty value if a test result on an iteration differs from the preceding result, other ways of calculating certainty values may be used.

Computer Programs and program carriers.

The invention may be implemented by a program or a set of programs, which when run on a computer or set of computers causes the computer(s) to implement the methods described herein above. In one implementation of the invention:-
a program is provided to monitor a computer to provide data to the database for the purpose of producing the data sets of excluded activities to analyse the data received from the monitoring program on the computer to produce the data set of excluded activities and
a program is provided on each computer 2n to control the power of the computer; and
alternatively, a program is provided on the administrator's workstation to analyse the data received from the monitoring programs on the computers to produce the data set of excluded activities.

The programs may be carried by one or more non-transitory computer-readable storage medium having computer readable instructions stored thereon or carriers. A carrier may be a signal, a communications channel, or a computer readable medium. A computer readable medium may be an article for example: a tape: a disc for example a CD or DVD: a hard disc: an electronic memory; or any other suitable non transitory carrier or data storage medium. The electronic memory may be a ROM, a RAM, Flash memory or any other suitable electronic memory device whether volatile or non-volatile.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims. It will be appreciated from the foregoing description that the claims may be combined in combinations other than those specifically recited in the claims.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory or other non-transitory means within a computing device operating according to the instructions.

Although various embodiments which incorporate the teachings of the present invention have been shown and described in detail herein, those skilled in the art can readily devise many other varied embodiments that still incorporate these teachings.

1. A method of monitoring processes running on a computer, comprising running on the computer a monitoring program which identifies a process running on the computer, and, for the identified process, determines whether or not one or more predetermined characteristics of the process comply with respective reference characteristics thereby to automatically distinguish whether the process is likely to be a productive process or a non-productive process.

2. A method of monitoring processes running on a computer, comprising running on the computer a monitoring program which identifies a process running on the computer, and, for the identified process, detecting the time pattern of running of the identified process and the resources it uses when running thereby to automatically determine whether the process is likely to be a productive process or a non-productive process.

3. A method according to claim 2, wherein the monitoring program detects the said time pattern by determining whether or not one or more predetermined time and resource characteristics of the process comply with respective reference characteristics.

4. A method according to claim 1, wherein each reference characteristic is associated with a test for determining whether or not a predetermined characteristic of the process complies with the associated reference characteristic and comprising producing a certainty value associated with the test, the aggregate of the one or more certainty values indicating the certainty of whether or not the process is productive or non-productive.

5. A method according to claim 4, wherein the test is re-iterated each time the process runs, and fro each iteration, the aggregate certainty value is incremented or decremented if the result of the test on that iteration differs from the result of the preceding iteration.

6. A method according to claim 1, wherein the said reference characteristics are characteristics of a process which is non-productive.

7. A method according to claim 1, wherein the said reference characteristics are characteristics of a process which is productive.

8. A method according to claim 1, comprising recording the name of the process and data identifying the or each occasion when the process runs.

9. A method according to claim 1, wherein a said reference characteristic is whether the process has run on the computer on a previous occasion.

10. A method according to claim 1, wherein a said predetermined characteristic is the time of running the process.

11. A method according to claim 10, wherein a said reference characteristic is whether the process has run at that time within a predetermined tolerance on a previous occasion.

12. A method according to claim 10, wherein a said reference characteristic is whether the process has run at a predetermined time within a predetermined tolerance.

13. A method according to claim 1, wherein the predetermined characteristics include the resources used by the process.

14. A method according to claim 13, wherein a said reference characteristic is whether the process has used the said resources on a previous occasion.

15. A method according to claim 13, wherein the said resources include one or more of a CPU, a data store and a network interface.

16. A method according to claim 1, wherein a said reference characteristic is whether the process receives data from a source outside the computer.

17. A method according to claim 1, wherein a said reference characteristic is whether the process communicates with one or more predetermined interne protocol addresses.

18. A method according to claim 1, wherein a said reference characteristic is whether the process is a service.

19. A method according to claim 1, wherein a said reference characteristic is whether the process is running in user context.

20. A method according to claim 1, comprising excluding any one of a predetermined set of one or more processes from the comparison of one or more predetermined characteristics of a process with respective reference characteristics,

21. A method according to claim 1, comprising storing the identity of the each process and data indicating whether or not is productive.

22. A method according to claim 1, further comprising the step of controlling the power consumption of the computer whilst a process is running in dependence on whether the process is productive or non-productive.

23. A non-transitory computer-readable storage medium having computer readable instructions stored thereon, the computer readable instructions being executable by a computerized device to cause the computerized device to perform a method of monitoring processes running on a computer, the method comprising:
identifying a process running on the computer; and
determining whether or not one or more predetermined characteristics of
the identified process comply with respective reference characteristics
thereby to automatically distinguish whether the process is likely to be a
productive process or a non-productive process.

24. A computer program product for monitoring processes running on a computer, the computer program product comprising:
a storage medium for storing computer instructions for execution by a processor for implementing a method comprising:
identifying a process running on the computer; and
determining whether or not one or more predetermined characteristics of the identified process comply with respective reference characteristics thereby to automatically distinguish whether the process is likely to be a productive process or a non-productive process.

25. A method of controlling power in a computer comprising identifying a process running in the computer, comparing the identification with a data set of identifications of processes and indications of whether the processes are productive or non-productive, and controlling the power according to the indications of whether the processes are productive or non-productive.

26. A method according to claim 25, wherein the identification of productive and non-productive processes is determined by running on the computer a monitoring program which identifies a process running on the computer, and, for the identified process, determines whether or not one or more predetermined characteristics of the process comply with respective reference characteristics thereby to automatically distinguish whether the process is likely to be a productive process or a non-productive process.

27. A non-transitory computer-readable storage medium having computer readable instructions stored thereon, the computer readable instructions being executable by a computerized device to cause the computerized device to perform a method for controlling the power state of a computer, the method comprising:
identifying a process running in the computer, comparing the identification with a data set of identifications of processes and indications of whether the processes are productive or non-productive, and controlling the power state according to the indications of whether the processes are productive or non-productive.

28. A computer program product for controlling power in a computer, the computer program product comprising:
a storage medium for storing computer instructions for execution by a processor for implementing a method comprising:
identifying a process running in the computer, comparing the identification with a data set of identifications of processes and indications of whether the processes are productive or non-productive, and controlling the power according to the indications of whether the processes are productive or non-productive.
